(19) United States
(12) Patent Application Publication
(10) Pub. No.: US 2014/0102949 A1
(43) Pub. Date: Apr. 17, 2014

(54) FLOTATION OF PARTICLES BY CHEMICALLY-INDUCED SPARGING OF BUBBLES

(71) Applicants: Michael R. Keller, Tulsa, OK (US); Ernest Dean Wallace, Beaumont (CA)

(72) Inventors: Michael R. Keller, Tulsa, OK (US); Ernest Dean Wallace, Beaumont (CA)

(73) Assignee: CONTINUUM EMVIRONMENTAL, LLC, Niagara Falls, NY (US)

(21) Appl. No.: 13/261,791

(22) PCT Filed: Jun. 15, 2012
(86) PCT No.: PCT/US2012/000291

§ 371 Date: Dec. 16, 2013

Related U.S. Application Data
(60) Provisional application No. 61/520,934, filed on Jun. 17, 2011.

(51) Int. Cl. B03D 1/06

(52) U.S. Cl. CPC B03D 1/06
USPC 209/165

(57) ABSTRACT

A method and apparatus in accordance with the present invention comprising a de-composable compound such as hydrogen peroxide as a primary additive to generate bubbles within a fluid medium such as an aqueous slurry of tar sands. The size range of bubbles, density (number per unit volume) of bubbles, and rate of in situ generations of bubbles are controlled by controlling process variables including but not limited to temperature, concentration of decomposable compound residence time, pressure, viscous shear, ratio of water to solids, pH of the slurry, shape of the separation vessel, and addition of one or more secondary process additives.

### RELATIONSHIP TO OTHER APPLICATIONS AND PATENTS

The present application draws priority from a pending U.S. Provisional Patent Application, Ser. No. 61/520,934, filed Jun. 17, 2011.

### TECHNICAL FIELD

The present invention relates to methods and apparatus for separating dissimilar materials; more particularly, to such separating by gas-assisted gravitational flotation; and most particularly, to a method and apparatus for separating by a plurality of dissimilar particulate solid and liquid materials, dispersed in a fluid medium, by controlled generation of gas bubbles in situ, defined herein as chemically-induced sparging.

### BACKGROUND OF THE INVENTION

It is known in the prior chemical engineering arts to separate particulate materials, such as globules of bitumen from inorganic particulates such as sand or silt dispersed in a water medium (also referred to herein as a “slurry”), by flotation in a tank. Typically, the bitumen globules tend to rise to the surface and the sand or silt particles tend to sink because of differences in specific gravity. The separation can be assisted by sparging of bubbles of air or other gases over the bottom of the tank wherein the inherent buoyant rise of the bubbles helps to sweep the bitumen globules upward through the slurry. These bubbles are not generated in situ but rather result from gas that is piped into the tank from an external source, typically through a device known generally as a sparger which is provided with a plurality of very small through which the gas enters the slurry below the surface. In general in the prior art, a not entirely satisfactory way has been found to control the characteristics of bubble populations by the sparging method. The formation of bubbles, and the size range of the bubbles generated, are controllable typically by selecting the pore size of the sparger and varying the temperature of the slurry, the height of the slurry column, and the gas flow rate. Typically, a relatively wide range of bubble diameters is produced. Exemplary particulates separated by such sparging and flotation in the prior art are mineral ores and bitumen globules derived from tar sainds.

A typical prior art gas flotation cell is available from Outotec Pty, Ltd in Australia.

The gas phase of any flotation cell is critical for optimum cell performance. Understanding and being able to vary the four key parameters in the gas phase can bring real results—with over 30% recovery improvement at the same grade, in one particular case. The recovery in a flotation cell is directly related to the amount of air added to the cell. Therefore there is a minimum air requirement for a given number of solid particles, below which efficient flotation cannot take place.

The method by which the air is added to the flotation cell in the prior art is also vitally important as it controls the size of the bubbles generated and the flow patterns in the cell. The flotation rotor and stator and the separation vessel must provide sufficient turbulence for bubble-particle collisions to occur and be able to generate bubbles in a certain size range depending on the particle size to be floated. The correct flow patterns up the cell of particles and bubbles must then be formed so that the particles are carried up to the froth phase without significant dropback occurring. In other words, if the gas phase is not handled properly, chances are the flotation cell is not performing as well as it could be.

There are several of gas phase parameters that can be directly measured and used to optimize the performance of this phase. Typically the gas phase can be described by four parameters:
1. Gas hold-up
2. Bubble size and bubble size distribution
3. Superficial gas velocity
4. Bubble surface area flux.

Gas hold-up (eg) is the volume of the gas in the flotation cell's slurry zone. The volume of gas reduces the slurry volume and therefore decreases the residence time available for flotation. The gas holdup depends on the amount of gas, typically in the form of atmospheric air, added to the cell and is a strong function of slurry viscosity. Typically, gas holdup is limited to between 5% and 15% of the total slurry volume, to maximize the cell volume and residence time.

Bubble size and its distribution (db) in a cell's slurry zone directly affect the particle/bubble interactions and hence flotation performance. For optimal performance, it is critical to generate bubbles of the correct diameter based on the size of particles to be floated. Smaller bubbles are generally required for fine particle flotation and larger bubbles for coarse particle flotation.

### EXAMPLE

1 m³ of air contains approximately 566 million bubbles of 1.5 mm diameter. At an aeration rate of 20 m³/min, 189 million bubbles/sec must be generated. Similarly, 1 ton of typical solids contains 1 billion (spherical particles) of 70 microns in size (after grinding). At a solids feed rate of 300 ton/hour, 83 million particles are generated per second. Of these 83 million particles/second, approximately 10% are collected in a rougher duty, 50% in a cleaner duty, and 85% in a recleaner duty. This corresponds to 2.3 bubbles per particle. This may seem sufficient; however, due to issues such as poor liberation, incorrect reagent addition, slurry chemistry, and oxidation, flotation recoveries of 100% are never achieved. If the bubble diameter were 2.0 mm, there would only be 80 million bubbles/second, which would reduce the number of bubbles per particle to fewer than one.

The bubble size and bubble size distribution can be measured in each flotation cell using a photographic Bubble Sizer. A sample of bubbles is photographed with a digital still camera and an automated image analysis procedure is used to size the collected bubbles from the digital images.

There are two main methods of calculating the average bubble diameter of a distribution. The first is to calculate the average of all bubble diameters in the distribution (known as the average bubble diameter d10). The second is to calculate the sum of all bubbles’ volume divided by the sum of all bubbles' surface area (known as the Sauter mean bubble diameter d32). The Sauter mean bubble diameter is always larger than the average bubble diameter as it takes more account of large bubbles with large volumes; therefore it is a better measure of bubble size.

A known commercially-available flotation mechanism is able to produce small bubbles with average bubble diameters between 1.0 mm and 1.5 mm and Sauter mean bubble diameters between 1.5 mm and 2.0 mm.

Superficial gas velocity (Jg) is the bubble's upward velocity relative to the cell cross-sectional area. It is proportional to the air addition rate and can indicate local flow patterns and gas short-circuiting. Excessive air addition increases bubble size, as the mechanism is unable to disperse the air, and is therefore detrimental to flotation performance. Controlling the air rate within an optimal range is very important.

The average rise velocity of bubbles in the flotation cell can be measured in combination with the bubble size measurements from the Bubble Sizer. A closed cylinder connected above the viewing chamber is filled with water before the bubble sizing takes place. During the bubble size measurement, the water in the cylinder is displaced by the rising air bubbles and the water level drops. The time taken (t) for the water level to fall a known distance, L, is measured and the superficial gas velocity calculated from the following equation:

Jg=Lt

Adjustments are then made to account for the pressure difference between the location of the sampling valve and where the measurement is made in the cylinder.

Typical superficial gas velocities are between 0.5 cm/sec and 1.5 cm/sec. As the air rises into the froth zone, the superficial gas velocity increases with decreasing surface area in the froth zone.

Superficial gas velocity measurements performed radially across a flotation cell can provide information on the gas dispersion efficiency. It is common for the superficial gas velocity to be slightly higher in the middle of the cell due to the air addition there. As the air rate increases, the bubbles rise faster in the cell center as the mechanism becomes less efficient at air dispersion, until the air cannot be dispersed and ‘boiling’ occurs.

Measurements of superficial gas velocity can also provide information on mechanism wear. If there is, for example, an uneven distribution across the cell, the sparging stator could be worn out on one side.

Bubble surface area flux (BSAF) is the amount of bubble surface area rising up a flotation cell per cross sectional area per unit time. It depends directly on the bubble size and superficial gas velocity. At shallow froth depths, BSAF is linearly proportional to the first order flotation rate constant; generally, the greater the bubble surface area flux, the higher the recovery rate in the slurry zone of a cell. However if excessive air is added, the recovery rate in the slurry zone can decrease due to ‘boiling’.

A significant amount of test work has been performed on bubble surface area flux over the past 15 years, and the relationship between bubble surface area flux and the first order flotation rate constant has been successfully validated for prior art mechanically induced sparging and holds for cells of all sizes, from 60 litres to 300 m³. It is essentially a direct measure of pulp zone flotation efficiency.

The bubble surface area flux can be measured directly using the following equation:

Sb=6.Jg×d32

### Where:

Sb=Bubble surface area flux (cm2/cm2 s)
d32=Sauter mean bubble diameter (cm)
Jg=Superficial gas velocity (cm/s)

Typically, BSAF ranges between 30 s-1 and 60 s-1 and can be varied directly by changing the air addition rate.

What is needed in the art is a method and apparatus wherein the size range of bubbles, density of bubbles (number per unit volume), and the rate of bubble generation in situ in a slurry by decomposition of a chemical agent in a process that can be controlled to desired and predetermined process aim points.

It is a principal object of the present invention to improve the rate, degree of separation, and percent recovery of particulates in a slurry by controlled chemically-induced sparging by bubbles formed in situ in the slurry.

### SUMMARY OF THE INVENTION

Briefly described, a method and apparatus in accordance with the present invention utilizes a decomposable compound such as hydrogen peroxide as a primary additive to generate bubbles within a fluid medium, e.g., an aqueous slurry of particulates having differing flotation properties. Bubbles generated within the slurry by chemical decomposition of the decomposable compound. The size range of bubbles, density (number per unit volume) of bubbles, and rate of in situ generation of bubbles may be controlled by controlling process variables such as temperature, concentration and flow rate of the decomposable compound, feed rate of the slurry, percent solids of the slurry (ratio of water to solids), residence time of the decomposable compound in the presence of the particulates, pH of the slurry, and addition of one or more secondary process additives including salts. As used herein, in situ should be taken to mean within the fluid medium. Bubble generation and materials separation can occur in a primary separation cell, a secondary and tertiary separation cells, and/or an auxiliary reactor.

### BRIEF DESCRIPTION OF THE DRAWINGS

The present invention will now be described, by way of example, with reference to the accompanying drawings, in which:

FIG. 1 is a block diagram of a flotation process in accordance with the present invention;

FIG. 2 is a graph showing the relationship between gas velocity and bubble size as a function of pH in a flotation separations process in accordance with the present invention;

FIG. 3 is a graph showing the relationship between gas velocity and BSAF as a function of pH;

FIG. 4 is a graph showing the relationship between gas velocity and BSAF as a function of both pH and salinity; and

FIG. 5 is a photograph showing chemically-induced sparging by engineered bubbles in accordance with the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

Referring now and specifically to the flotation phenomenon, it will be seen that particulate separation by flotation in a novel process wherein bubbles are generated spontaneously by chemical decomposition within the slurry itself is fundamentally different from conventional prior art flotation processes wherein bubbles are formed by sparging of air into the slurry. This novel process is defined herein as “chemically-induced sparging”.

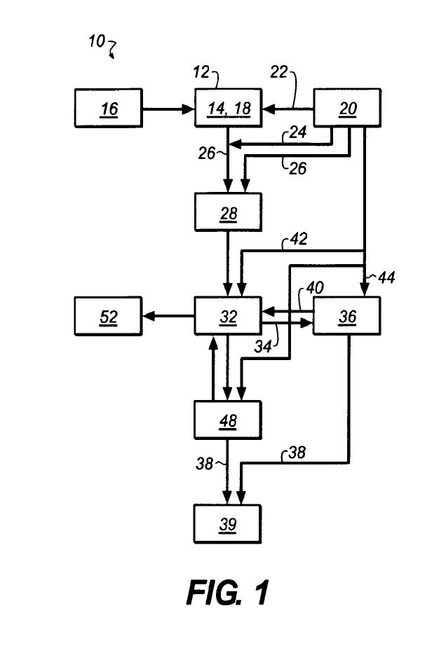

Referring to FIG. 1, a block diagram 10 is shown of a flotation apparatus in accordance with the present invention. A mixing vessel 12 contains a plurality of prepared, crushed particulates 14. A liquid material 16, e.g., water, is added to material 14, forming a slurry 18. The slurry 18 is mixed for a predetermined time to a given consistency and may be tempered or provided with other addenda (not shown), e.g. salt such as sodium chloride. A solution 20 of a decomposable compound, e.g., hydrogen peroxide or sodium peroxide, is added 22 to slurry 18 at, optionally, mixing vessel 12, to 24 an exit line 26 carrying slurry 18 from vessel 12, to 26 a subsequent vessel 28 receivable of slurry 18, and/or to 30 a primary separation vessel (PSV) 32. Vessel 12 and vessel 32 may be the same vessel. In PSV 32, the decomposable compound is introduced beneath the surface of the slurry and is controllably decomposed to form “engineered” bubbles of a desired size diameter range, distribution within PSV 32, and gas flow rate upward. Slurry 18 is dynamically separated in known fashion into an upper froth layer 34 that is removable to an additional separator 36 as may be needed, from which flows a suspension 39 of a first particulate species 38 that typically is the desired species of the flotation-separated slurry. The suspension may be de-watered in known fashion. A bottom layer 40 may be returned to PSV 32 for reprocessing. Solution 20 may be added 42,44, optionally to vessels 32 and 36. Middlings layer 46 similarly is sent to an another separation vessel 48 for additional treatment resulting in additional species 38, and bottom layer 50 may be returned to PSV 32 for further processing. Separated bottoms 52 are removed from PSV 32 and discarded or otherwise used as may be desired

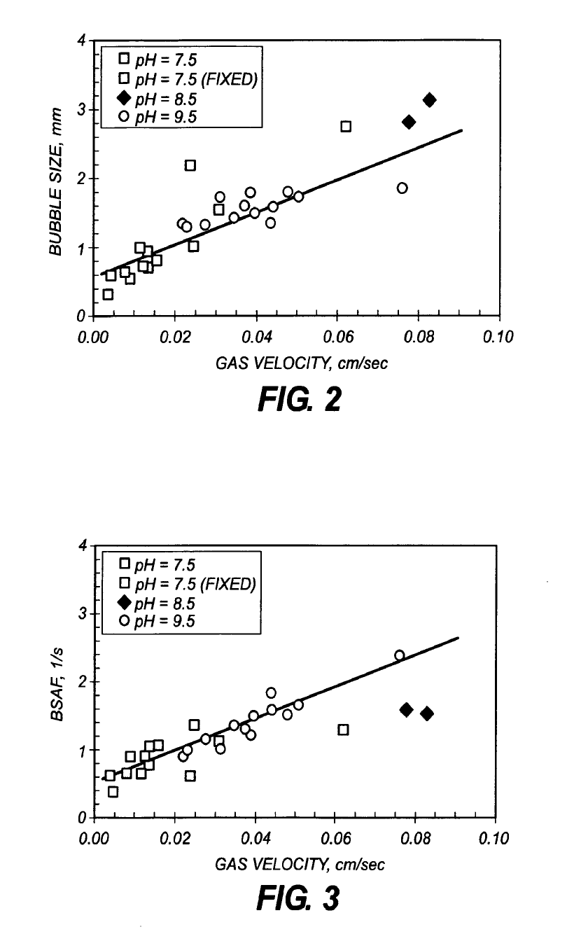

Referring now to FIG. 2, it is seen that pH can be a strongly controlling factor in controlling bubble size and gas velocity. A currently preferred range of pH is between about 8.0 and 9.5.

Referring to FIG. 3, it is seen that BSAF and gas velocity are also strongly dependent on pH. Again, a pH range of between about 8.0 and 9.5 produces the highest levels of BSAF which is the primary controlling factor in efficiency and rate of recovery in a flotation process as described above.

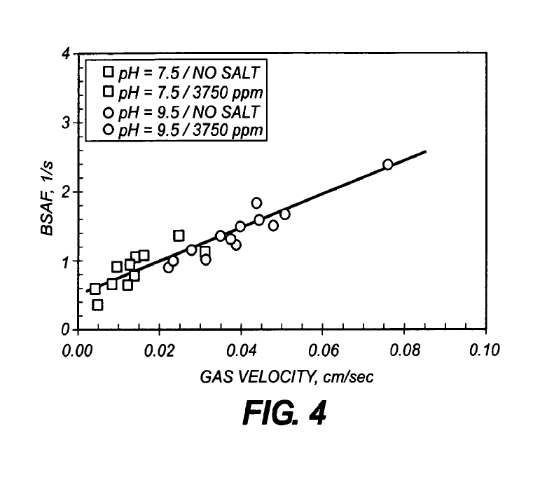

Referring to FIG. 4, it is seen that salinity is a control factor, with gas velocity and BSAF increasing with increased salinity.

Coincidentally and beneficially, salt level and pH are both in the desired range in a prior art process widely used for recovering bitumen globules from tar sands, making the present process especially useful.

An added benefit of chemically-induced sparging is that in many commercial processes there can be a wide range of ore composition and behavior, which can be accommodated immediately by adjustment of process parameters. Such accommodation is simply not possible with prior art mechanical spargers.

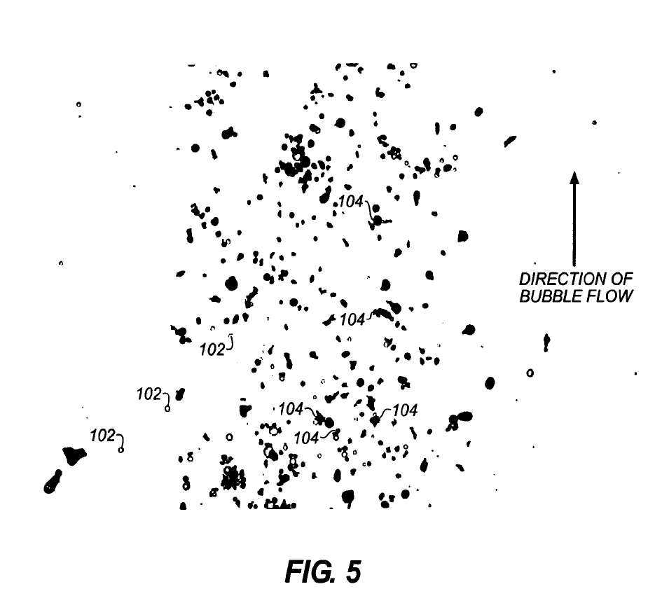

Referring now to FIG. 5, the prior art process depends principally or solely upon the upward motion of the bubbles to mechanically carry the desired particles upward for discharge over a weir.

In contrast, the present process 100 is believed by the inventors to have the benefit of forming the bubbles 102 right from the molecular level right at the surface of the desired particles. As a result, and in stark contrast to the prior art, a substantial proportion of the formed bubbles remain attached 104 to the particles and act like little oxygen balloons to buoy the particles upward.

Accordingly, the prior art rules for optimum bubble formation and bubble characteristics may not be applied directly but rather must be modified in consonance with the present novel mechanism of bubble formation and flotation.

From the foregoing description it will be apparent that there have been provided improved methods and apparatus for separating dissimilar particulate materials dispersed in a fluid medium, especially for economically recovering petroleum-like hydrocarbon residues from particulate mineral substrates, especially hydrocarbonaceous ores such as tar sands, and for discharging a substrate residue environmentally suitable for landfill disposal. Variations and modifications of the herein described methods and apparatus, in accordance with the invention, will undoubtedly suggest themselves to those skilled in this art. Accordingly, the foregoing description should be taken as illustrative and not in a limiting sense.

What is claimed is:

1. A method for separating a plurality of dissimilar particulate materials dispersed together in a fluid medium, comprising the steps of:
a) controllably adding to said fluid medium an amount of a compound that is decomposable in said fluid medium to yield a gas;
b) controllably decomposing said compound to yield said gas;
c) forming bubbles of said gas within said fluid medium; and
d) allowing said bubbles of gas to attach preferentially to particulates of at least one of said plurality of dissimilar materials to cause said one of said dissimilar particulate materials to buoyantly rise preferentially in said fluid medium,
wherein the size range, number of bubbles per unit volume of fluid medium, gas flow rate upward, and BSAF are controllable by controlling to predetermined aims a plurality of process variables exerted upon the whole of said fluid medium, and
wherein at least a portion of said bubbles formed within said fluid medium are formed beginning at the gas molecular level.

2. A method in accordance with claim 1 wherein said controllably adding step is carred out in an apparatus including at least a mixing tank and a flotation vessel.

3. A method in accordance with claim 2 wherein said forming step is carried out in said flotation vessel.

4. A method in accordance with claim 1 wherein at least one of said dissimilar materials includes a mineral.

5. A method in accordance with claim 1 wherein at least one of said dissimilar materials includes a hydrocarbon.

6. A method in accordance with claim 1 wherein said plurality of dissimilar materials includes tar sand grains.

7. A method in accordance with claim 1 wherein said plurality of dissimilar materials includes ruptured tar sand grains having separated mineral portions and hydrocarbon portions.

8. A method in accordance with claim 1 wherein at least one of said process variables is selected from the group consisting of slurry temperature; concentration of said decomposable compound; length of time after said decomposable compound is added to said fluid medium; pressure on said fluid medium; viscous shear of said fluid medium; ratio of fluid to solids in said fluid medium; pH of said fluid medium; shape of a separation vessel containing said fluid medium; and combinations thereof.

9. A method in accordance with claim 1 wherein said fluid medium is a slurry.

10. A method in accordance with claim 1 wherein said fluid is water.

11. A method in accordance with claim 1 wherein said fluid medium is alkaline.

12. A method in accordance with claim 1 wherein said fluid medium further includes a salt.

13. A method in accordance with claim 2 wherein said separation vessel is a primary separation vessel, wherein said bubbles formed in said separation vessel define a first population of bubbles having first characteristics, and wherein said decomposing step and the beginning of said forming step are carried out in said primary separation vessel.

14. A method in accordance with claim 13 wherein an additional amount of said compound that is decomposable in said fluid medium is added in a said secondary separation vessel.

15. A method in accordance with claim 14 wherein said apparatus further comprises an additional vessel in communication with at least one of said primary separation cell and said secondary separation vessel.

16. A method in accordance with claim 15 comprising the steps of:
e) charging said additional vessel with additional of said fluid medium containing particulates;
f) passing a secondary solution of said decomposable compound through said fluid medium to generate bubbles by decomposition of said compound, wherein said bubbles define a secondary population of bubbles having secondary characteristics in said secondary solution; and
g) passing said bubble-containing secondary solution into one of said first and second separation vessels.

17. A method in accordance with claim 2 comprising the further step of injecting a gas into said fluid medium.

18. A method in accordance with claim 16 comprising the further step of injecting a gas into said additional of said fluid medium in said additional vessel.

19. A method in accordance with claim 1 in which bubble size is controlled by a process variable.

20. A method in accordance with claim 19 in which bubble size is controlled by modifying the volume of the fluid medium and quantity of solids contained therein.

21. A method in accordance with claim 19 in which bubble size is controlled by modifying the design of the reactor containing the fluid medium and solids contained therein.

22. A method in accordance with claim 19 in which bubble size is controlled by modifying the pH of the fluid medium.

23. A method in accordance with claim 19 in which bubble size is controlled by modifying the salt content of the fluid medium.

24. A method in accordance with claim 19 in which bubble size is controlled by modifying the concentration in the fluid medium of the compound that decomposes to form the gas.

25. A method in accordance with claim 19 in which bubble size is controlled by modifying the temperature of the fluid medium.

26. A method in accordance with claim 1 in which bubble surface area flux is controlled by a process variable.

27. A method in accordance with claim 26 in which bubble surface area flux is controlled by modifying the volume of the fluid medium and quantity of solids contained therein.

28. A method in accordance with claim 26 in which bubble surface area flux is controlled by modifying the design of the reactor containing the fluid medium and the solids contained therein.

29. A method in accordance with claim 26 in which bubble surface area flux is controlled by modifying the pH of the fluid medium.

30. A method in accordance with claim 26 in which bubble surface area flux is controlled by modifying the salinity of the fluid medium.

31. A method in accordance with claim 1 wherein said portion of said bubbles formed within said fluid medium are formed on the surfaces of said particulates of at least one of said plurality of dissimilar materials.

32. A method in accordance with claim 1 wherein a portion of said bubbles formed within said fluid medium has an average bubble diameter less than 1.0 mm.
